(19) United States
(12) Patent Application Publication
(10) Pub. No.: US 2024/0232744 A9
(43) Pub. Date: Jul. 11, 2024

(54) OPERATION MANAGEMENT APPARATUS

(71) Applicant: TOYOTA JIDOSHA KABUSHIKI KAISHA, Toyota-shi Aichi-ken (JP)

(72) Inventors: Yu NAGATA, Chofu-shi Tokyo-to (JP); Ibuki SHIMADA, Miyoshi-shi Aichi-ken (JP)

(73) Assignee: TOYOTA JIDOSHA KABUSHIKI KAISHA, Toyota-shi Aichi-ken (JP)

(21) Appl. No.: 18/488,270

(22) Filed: Oct. 17, 2023

(30) Foreign Application Priority Data
Oct. 19, 2022 (JP) 2022-167973

(51) Int. Cl. G06Q 10/0631; G06Q 10/20; G07C 5/00; G07C 5/08

(52) U.S. Cl. CPC G06Q 10/063112; G06Q 10/20; G07C 5/008; G07C 5/0808

(57) ABSTRACT

An operation management apparatus operates one or more vehicles by automated driving. The operation management apparatus includes a controller configured to predict, for each vehicle based on operation plan data, a time point at which driving is switched from automated driving to manual driving, identify, as a target vehicle, a vehicle for which time until the predicted time point is less than a threshold value, acquire vehicle data and/or operation record data, determine, based on the acquired vehicle data or the acquired operation record data, one or more types of abnormality having occurred in the target vehicle, designate, from among a plurality of workers according to the determined types of abnormality, a first worker who is to perform a maintenance operation on the target vehicle at a site near the target vehicle, and notify the first worker of information that prompts the first worker to take care of the abnormality.

### CROSS-REFERENCE TO RELATED APPLICATION

This application claims priority to Japanese Patent Application No. 2022-167973 filed on Oct. 19, 2022, the entire contents of which are incorporated herein by reference.

### TECHNICAL FIELD

The present disclosure relates to an operation management apparatus.

### BACKGROUND

Patent Literature (PTL) 1 discloses a vehicle operation management system in which information is shared between an operation management center and a maintenance center to set maintenance periods and maintenance details of vehicles.

### CITATION LIST

### Patent Literature

PTL 1: JP 2006-073019 A

### SUMMARY

In operation management systems that operate automated driving vehicles according to schedules, the driving of a vehicle may be switched from automated driving to manual driving for the purpose of maintenance and inspection, for example. To switch the driving, it is necessary to assign a worker, such as a vehicle maintenance staff member, to the vehicle. However, worker assignment operation must be performed by taking into account, for example, the conditions of the vehicle, tasks of which workers can be in charge, the operation states of the workers, and the like, thus requiring much time and effort. When it takes long time to assign the worker, the vehicle has to be on standby during the time, thus reducing the operation efficiency of the vehicle.

It would be helpful to improve the operation efficiency of a vehicle.

An operation management apparatus according to the present disclosure is an operation management apparatus that operates one or more vehicles by automated driving according to a schedule, the operation management apparatus including a controller configured to:
predict, for each vehicle based on operation plan data corresponding to the schedule, a time point at which driving is switched from automated driving to manual driving;
identify, as a target vehicle, a vehicle for which time until the predicted time point is less than a threshold value;
acquire vehicle data and/or operation record data, the vehicle data being obtained by monitoring a condition of the target vehicle, the operation record data being obtained by monitoring travel of the target vehicle;
determine, based on the acquired vehicle data or the acquired operation record data, one or more types of abnormality having occurred in the target vehicle;
designate, from among a plurality of workers according to the determined types of abnormality, a first worker who is to perform maintenance work on the target vehicle at a site near the target vehicle; and
notify the first worker of information that prompts the first worker to take care of the abnormality.

According to the present disclosure, the operation efficiency of a vehicle is improved.

### BRIEF DESCRIPTION OF THE DRAWINGS

In the accompanying drawings:

FIG. 1 is a diagram illustrating a configuration of an operation management system according to an embodiment of the present disclosure;

FIG. 2 is a block diagram illustrating a configuration of an operation management apparatus according to the embodiment of the present disclosure;

FIG. 3 is a block diagram illustrating a configuration of a server apparatus according to the embodiment of the present disclosure;

FIG. 4 is a block diagram illustrating a configuration of a vehicle according to the embodiment of the present disclosure;

FIG. 5 is a block diagram illustrating a configuration of an information processing apparatus mounted in the vehicle according to the embodiment of the present disclosure;

FIG. 6 is a flowchart illustrating operations of the operation management apparatus according to the embodiment of the present disclosure;

FIG. 7 is a diagram illustrating an example of job classification data according to the embodiment of the present disclosure; and

FIG. 8 is a diagram illustrating an example of task management data according to the embodiment of the present disclosure.

### DETAILED DESCRIPTION

An embodiment of the present disclosure will be described below, with reference to the drawings.

In the drawings, the same or corresponding portions are denoted by the same reference numerals. In the description of the present embodiment, detailed description of the same or corresponding portions is omitted or simplified as appropriate.

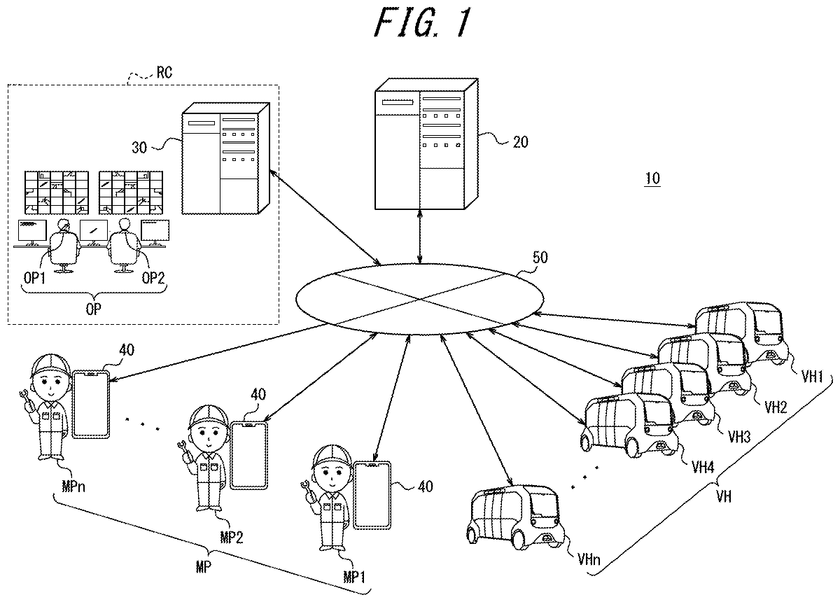

A configuration of an operation management system 10 according to the present embodiment will be described with reference to FIG. 1.

The operation management system 10 according to the present embodiment includes an operation management apparatus 20, a server apparatus 30, one or more vehicles VH, and terminal apparatuses 40 of a plurality of workers MP. The operation management system 10 is used, for example, to provide a mobility service such as MaaS. The term “MaaS” is an abbreviation of Mobility as a Service.

The operation management apparatus 20 can communicate with the server apparatus 30 and each terminal apparatus 40 via a network 50 such as the Internet. The operation management apparatus 20 may be able to communicate with each vehicle VH via the network 50.

The server apparatus 30 can communicate with each vehicle VH, as well as the operation management apparatus 20, via the network 50. The server apparatus 30 may be able to communicate with each terminal apparatus 40 via the network 50.

The operation management apparatus 20 is installed in a facility such as a data center to acquire, store, and process data, such as operation plan data D1, vehicle data D2, job classification data D4, and task management data D5. The operation plan data D1 is for managing a schedule for operating the vehicles VH. The vehicle data D2 is obtained by monitoring the conditions of each vehicle VH. The job classification data D4 indicates, on a worker-by-worker basis, job classifications of the plurality of workers MP in association with the types of abnormality. The task management data D5 indicates the operation states of the plurality of workers MP. The operation management apparatus 20 is operated by an operation manager who manages the operation management system 10. The operation management apparatus 20 is a computer such as a server that belongs to a cloud computing system or other computing system. The operation management apparatus 20 may be installed in a control room of the operation management system 10 and used by the operation manager. Alternatively, the operation management apparatus 20 installed in the control room may be shared by two or more operation managers. In the present embodiment, the operation management apparatus 20 operates the one or more vehicles VH by automated driving according to the schedule indicated by the operation plan data D1.

The server apparatus 30 is installed in a facility such as a data center. In the present embodiment, the server apparatus 30 is installed in a remote monitoring center RC to remotely monitor automated operations of each vehicle VH. The server apparatus 30 is a computer such as a server that belongs to a cloud computing system or other computing systems. The server apparatus 30 acquires, stores, and processes, in the remote monitoring center RC, operation record data D3 obtained by monitoring travel of each vehicle VH.

Each vehicle VH is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicles VH are MaaS dedicated vehicles in the present embodiment, but may be AVs the driving of which is automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers.

Each terminal apparatus 40 is held by each worker MP. Each terminal apparatus 40 is, for example, a mobile device such as a mobile phone, a smartphone, or a tablet, or a PC. The term “PC” is an abbreviation of personal computer. Each worker MP is a site staff member who waits as a maintenance worker for the vehicles VH in a site, such as a garage or a maintenance area, for example.

The network 50 includes the Internet, at least one WAN, at least one MAN, or a combination thereof. The term “WAN” is an abbreviation of wide area network. The term “MAN” is an abbreviation of metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

In the operation management system 10, the operation management apparatus 20 functions as a mobility service platform. As an overview, the operation management apparatus 20 operates the one or more vehicles VH by automated driving according to a schedule. In the present embodiment, the schedule corresponds to operation plan data D1 and is managed by the operation management apparatus 20.

In the present embodiment, each vehicle VH is a bus that transports one or more passengers. Each vehicle VH is operated as a regular fixed-route operation bus that travels by automated driving according to a predetermined schedule. When an operation start time for a certain vehicle approaches, operation plan data D1 corresponding to a schedule for the vehicle is transmitted from the operation management apparatus 20 to an information processing apparatus 14 installed in the vehicle. The information processing apparatus 14 will be described later. The information processing apparatus 14 controls the vehicle to travel by automated driving according to the schedule indicated by the operation plan data D1. Here, the driving of each vehicle VH may be switched from automated driving to manual driving at any time. For example, it can be assumed that the driving of the vehicle VH is switched from automated driving to manual driving for maintenance and inspection or the like at the point of returning to a garage after the vehicle has arrived at the last stop, which is an end point of a route for each vehicle VH.

In the present embodiment, information about each vehicle VH is transmitted to each terminal apparatus 40 as the driving of each vehicle VH is switched from automated driving to manual driving. The information about each vehicle VH includes information indicating the details of a maintenance task that may be performed on each vehicle VH. Each worker MP performs, according to the information transmitted to the terminal apparatus 40, a maintenance task on the vehicle VH after having been switched to manual driving, at a site near the vehicle VH. As an example, the driving of each vehicle VH is switched from automated driving to manual driving within a manual driving transition frame in the garage as a standby location. The vehicle VH that has been switched from automated driving to manual driving is driven by a designated worker MP from within the manual driving transition frame to a parking space or a maintenance area in the garage. Upon confirming that the vehicle VH has exited the manual driving transition frame by manual driving, the operation management apparatus 20 updates the operation state of the designated worker MP. A remote operator OP approves the end of the automated driving of the vehicle VH that has arrived at the manual driving transition frame, and enters, as a handoff item into the server apparatus 30, information indicating an abnormality or the like detected by a monitor or the like during remote operation assistance for each vehicle VH. The remote operator OP may enter, as the handoff item into the server apparatus 30, information indicating the details of an inquiry or a complaint from a passenger received during remote operation assistance for each vehicle VH or information indicating the details of a trouble that has arisen with a passenger. In the present embodiment, maintenance work includes, as well as taking over the driving of the vehicle after having switched to manual driving from the remote operator OP at the site, a task of maintenance and repair of the vehicle, and taking care of the handoff item from the remote operator OP. In other words, the maintenance work may include a task of vehicle passenger service or a task of adaptation to surrounding environment. In the present embodiment, the task of passenger service includes responding to an inquiry or a complaint from a passenger received during remote operation assistance for each vehicle VH or dealing with a trouble that has arisen with a passenger. The task of adaptation to surrounding environment includes adjusting various sensors and other devices mounted on the vehicle VH to the surrounding environment.

In the present embodiment, one or more remote operators OP at the remote monitoring center RC provide remote assistance for the automated driving of each vehicle VH. In other words, the remote operators OP can monitor and remotely control each vehicle VH during automated driving. The one or more remote operators OP may include remote operators other than remote operators OP1 and OP2. In the present embodiment, operation record data D3 is transmitted from each vehicle VH to the server apparatus 30 or the operation management apparatus 20. Specifically, the operation record data D3 is transmitted from the information processing apparatus 14 mounted in each vehicle VH. In the present embodiment, the information processing apparatus 14 is, for example, a computer in which automated driving control software is installed or a device capable of carrying sensors such as a camera and lidar, but not limited thereto and may be any device. The information processing apparatus 14 is mounted at any position in the vehicle VH, for example, on the roof top of the vehicle VH.

In the present embodiment, the operation record data D3 includes, in addition to various travel data obtained by monitoring the travel of the vehicle VH during operation, information that indicates the communication state between the information processing apparatus 14 and a control apparatus 12 during the automated driving of the vehicle VH, the amount of sensor noise having occurred at the sensors such as the camera and lidar mounted in the information processing apparatus 14, a time period in which the vehicle VH has been temporarily remotely operated during the automated driving, and the like. The operation record data D3 may further include a time and a location at which the sensor noise has occurred and a cumulative time for which the driving of the vehicle VH has been operated remotely. Alternatively, each remote operator OP may enter, as a handoff item, information indicating abnormality or the like detected by a monitor or the like during remote operation assistance of each vehicle VH into the server apparatus 30, to include such information in the operation record data D3. The operation record data D3 may further include other information also entered by the remote operator OP as a handoff item into the server apparatus 30, the information indicating the details of an inquiry or a complaint from a passenger received during remote operation assistance for each vehicle VH or indicating the details of a trouble that has arisen with a passenger.

In the present embodiment, the operation management apparatus 20 acquires vehicle data D2 from each vehicle VH. The vehicle data D2 includes information obtained by monitoring the conditions of each vehicle VH. The vehicle data D2 includes, for example, signals from warning lights mounted in each vehicle VH and parameter values, such as tire pressure, the amount of a brake step per acceleration, and the amount of battery charge for each vehicle VH. The vehicle data D2 may include images acquired by image sensors, such as cameras, mounted on each vehicle VH.

The vehicle data D2 may be acquired by any procedure, such as the following procedure. The vehicle data D2 is acquired constantly or at predetermined time intervals by a communicator 11. The communicator 11 communicates with a plurality of ECUs 13 mounted in each vehicle VH via an in-vehicle network, such as CAN, or dedicated lines, and transmits the vehicle data D2 to the operation management apparatus 20. The term “ECU” is an abbreviation of Electronic Control Unit. The term “CAN” is an abbreviation of Controller Area Network. The vehicle data D2 is uploaded from the communicator 11 and stored in a cloud server. The operation management apparatus 20 communicates with the cloud server to acquire the vehicle data D2 stored in the cloud server. Alternatively, the operation management apparatus 20 may be that cloud server. In other words, the vehicle data D2 may be stored in the operation management apparatus 20.

In the present embodiment, the operation management apparatus 20 predicts, for each vehicle based on the operation plan data D1, a time point T1 at which the driving of each vehicle VH is switched from automated driving to manual driving, and identifies, as a target vehicle VHt, a vehicle VHi for which time until the predicted time point T1 is less than a threshold value. The operation management apparatus 20 acquires vehicle data D2t obtained by monitoring the conditions of the target vehicle VHt and/or operation record data D3t obtained by monitoring travel of the target vehicle VHt, and determines, based on the acquired vehicle data D2t or the acquired operation record data D3t, one or more types of abnormality having occurred in the target vehicle VHt. The operation management apparatus 20 designates, from among a plurality of workers MP according to the determined types of abnormality, a first worker MP1 who is to perform maintenance work on the target vehicle VHt at a site near the target vehicle VHt. The operation management apparatus 20 notifies the first worker MP1 of information that prompts the first worker MP1 to take care of the abnormality.

According to the present embodiment, a worker who is to maintain a vehicle is automatically selected as the vehicle is switched from automated driving to manual driving. Thus, time and effort required to assign the worker is reduced. Therefore, the operation efficiency of the vehicle is improved.

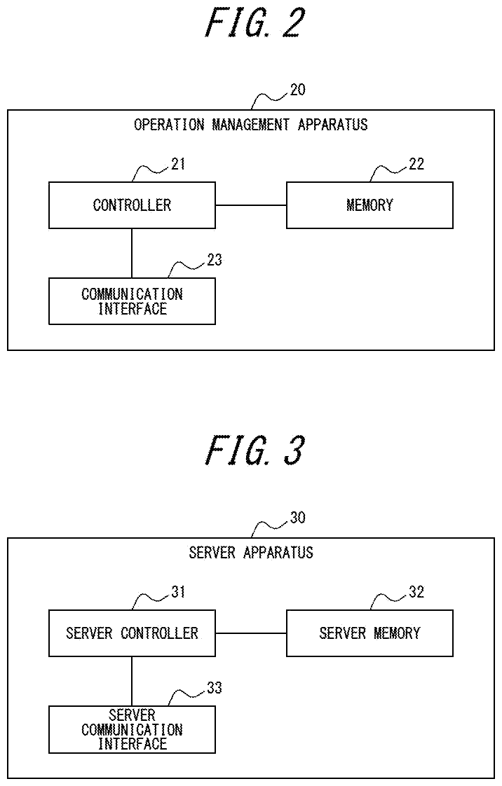

A configuration of the operation management apparatus 20 according to the present embodiment will be described with reference to FIG. 2.

The operation management apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the operation management apparatus 20 while controlling components of the operation management apparatus 20.

The memory 22 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the operation management apparatus 20 and data obtained by the operations of the operation management apparatus 20. In the present embodiment, the memory 22 may store the operation plan data D1.

The communication interface 23 includes at least one interface for communication. The interface for communication is, for example, a LAN interface. The communication interface 23 receives data to be used for the operations of the operation management apparatus 20, and transmits data obtained by the operations of the operation management apparatus 20. In the present embodiment, the communication interface 23 communicates with the server apparatus 30 and each terminal apparatus 40. The communication interface 23 may communicate with each vehicle VH. For example, the controller 21 may receive the vehicle data D2 from each vehicle VH via the communication interface 23. The controller 21 may have the vehicle data D2 constructed as a database in the memory 22.

The functions of the operation management apparatus 20 are realized by execution of a program according to the present embodiment by a processor serving as the controller 21. That is, the functions of the operation management apparatus 20 are realized by software. The program causes a computer to execute the operations of the operation management apparatus 20, thereby causing the computer to function as the operation management apparatus 20. That is, the computer executes the operations of the operation management apparatus 20 in accordance with the program to thereby function as the operation management apparatus 20.

The program can be stored in a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM in which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using a processor, and executes processes in accordance with the read program using the processor. The computer may read the program directly from the portable medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the operation management apparatus 20 may be realized by a programmable circuit or a dedicated circuit serving as the controller 21. That is, some or all of the functions of the operation management apparatus 20 may be realized by hardware.

A configuration of the server apparatus 30 according to the present embodiment will be described with reference to FIG. 3.

The server apparatus 30 includes a server controller 31, a server memory 32, and a server communication interface 33.

The server controller 31 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The server controller 31 executes processes related to operations of the server apparatus 30 while controlling components of the server apparatus 30.

The server memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The server memory 32 functions as, for example, a main memory, an auxiliary memory, or a cache memory. The server memory 32 stores data to be used for the operations of the server apparatus 30 and data obtained by the operations of the server apparatus 30. In the present embodiment, the operation record data D3 may be stored in the server memory 32.

The server communication interface 33 includes at least one interface for communication. The interface for communication is, for example, a LAN interface. The server communication interface 33 receives data to be used for the operations of the server apparatus 30, and transmits data obtained by the operations of the server apparatus 30. In the present embodiment, the server communication interface 33 communicates with the operation management apparatus 20 and each vehicle VH. The server communication interface 33 may communicate with each terminal apparatus 40.

For example, the server controller 31 receives the operation record data D3 from each vehicle VH via the server communication interface 33. The server controller 31 has the operation record data D3 constructed as a database in the server memory 32.

Some or all of the functions of the server apparatus 30 may be realized by a programmable circuit or a dedicated circuit serving as the server controller 31. That is, some or all of the functions of the server apparatus 30 may be realized by hardware.

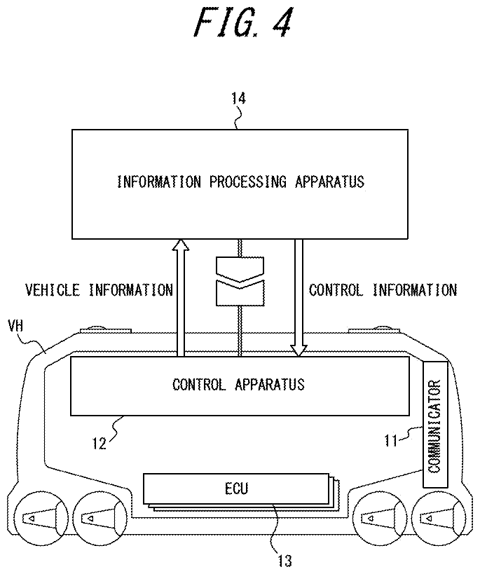

A configuration of each vehicle VH according to the present embodiment will be described with reference to FIG. 4.

Each vehicle VH includes a communicator 11, a control apparatus 12, and a plurality of ECUs 13. The communicator 11, the control apparatus 12, and each ECU 13 are communicably connected to one another via an in-vehicle network, such as CAN, or dedicated lines, for example.

The communicator 11 is an in-vehicle communicator, such as a DCM. The term “DCM” is an abbreviation of Data Communication Module. The communicator 11 includes a communication module for connecting to the network 50. For example, the communicator 11 may include a communication module compliant with mobile communication standards such as the 4G standards or the 5G standards. The term “4G” is an abbreviation of 4th Generation. The term “5G” is an abbreviation of 5th Generation. In the present embodiment, each vehicle VH is connected to the network 50 via the communicator 11.

The control apparatus 12 is an apparatus configured to perform vehicle control based on control information received from the information processing apparatus 14. The control information is information generated by the information processing apparatus 14 using automated driving software. The vehicle control is executed by cooperation between the control apparatus 12 and each ECU 13. In other words, the plurality of ECUs 13 cooperates with the control apparatus 12 to control operations of the vehicle. Specifically, the control apparatus 12 receives the control information at control timings that occur at predetermined intervals. The plurality of ECUs 13 receives a control command based on the control information from the control apparatus 12, and controls the operations of the vehicle VH according to the control command. For example, the plurality of ECUs 13 controls an operation amount for the vehicle VH to be a value indicated by the control command. The plurality of ECUs 13 collects measured values of control amounts or operation amounts for the vehicle VH from various sensors mounted in the vehicle VH at each control timing, and transmits the measured values to the control apparatus 12. The control apparatus 12 transmits the measured values transmitted from the plurality of ECUs 13 to the information processing apparatus 14 as vehicle information. The vehicle information is used by the information processing apparatus 14 to generate the control information. The plurality of ECUs 13 may transmit the collected measured values to the communicator 11. The communicator 11 transmits the measured values transmitted from the plurality of ECUs 13 to the operation management apparatus 20 as the vehicle data D2.

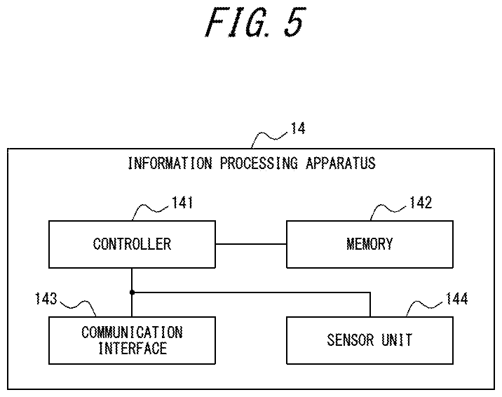

A configuration of the information processing apparatus 14 according to the present embodiment will be described with reference to FIG. 5.

The information processing apparatus 14 includes a controller 141, a memory 142, a communication interface 143, and a sensor unit 144.

The controller 141 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 141 executes processes related to operations of the information processing apparatus 14 while controlling components of the information processing apparatus 14. The controller 141 generates, transmits, and stores control information using automated driving software.

The memory 142 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 142 functions as, for example, a main memory, an auxiliary memory, or a cache memory. The memory 142 stores data to be used for the operations of the information processing apparatus 14 and data obtained by the operations of the information processing apparatus 14. The information stored in the memory 142 may be updated with, for example, update information acquired from the control apparatus 12 via the communication interface 143.

The communication interface 143 includes at least one interface for communication. The interface for communication is, for example, a LAN interface. The communication interface 143 receives data to be used for the operations of the information processing apparatus 14, and transmits data obtained by the operations of the information processing apparatus 14. In the present embodiment, the communication interface 143 communicates with each vehicle VH. The communication interface 143 may communicate with the server apparatus 30.

The sensor unit 144 includes one or more sensors that detect information regarding the operations of the information processing apparatus 14 or surrounding environment. The types and number of the sensors included in the sensor unit 144 are determined according to objectives of an operation manager. For example, the sensor unit 144 may include any sensor, such as a lidar, an acceleration sensor, an angular velocity sensor, a magnetic sensor, a barometric pressure sensor, an illumination sensor, a temperature sensor, and an image sensor (camera). The sensor unit 144 acquires, as sensor information, information detected by each sensor. For example, the sensor information of the sensor unit 144 may include information detected by the lidar, an image of environment surrounding the vehicle VH, acceleration and angular velocity of the vehicle VH, magnetic field, air pressure, and the like.

Some or all of the functions of the information processing apparatus 14 may be realized by a programmable circuit or a dedicated circuit serving as the controller 141. That is, some or all of the functions of the information processing apparatus 14 may be realized by hardware.

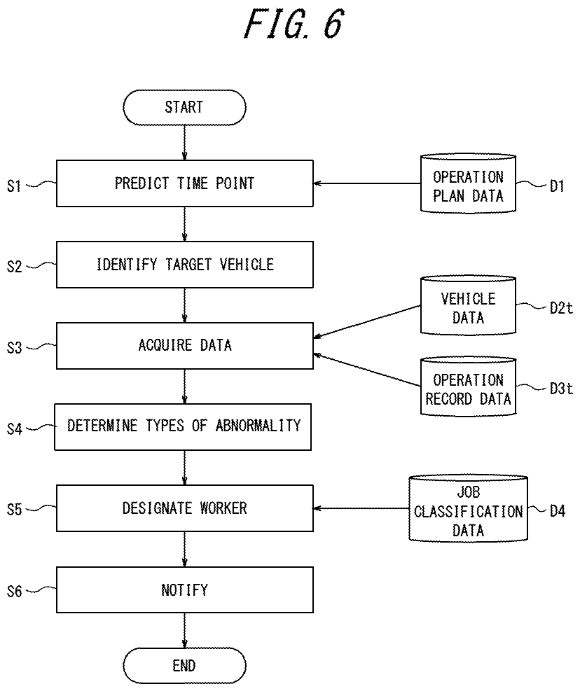

Operations of the operation management apparatus 20 according to the present embodiment will be described with reference to FIGS. 6 to 8. The operations correspond to an operation management method according to the present embodiment.

In step S1 of FIG. 6, the controller 21 of the operation management apparatus 20 predicts, for each vehicle VH based on operation plan data D1, a time point T1 at which driving is switched from automated driving to manual driving. Specifically, the controller 21 reads the operation plan data D1 stored in the memory 22. Based on the read operation plan data D1, the controller 21 predicts, as the time point T1, a time at which each vehicle VH is to return to a garage. For example, the controller 21 predicts, as the time point T1, a time obtained by adding, to a predicted arrival time at the last stop as the end point of each route indicated by the operation plan data D1, time it takes to travel from the last stop to the garage.

In step S2 of FIG. 6, the controller 21 of the operation management apparatus 20 identifies, as a target vehicle VHt, a vehicle VHi for which time until the predicted time point T1, which is predicted for each vehicle VH, is less than a threshold value. The threshold value may be set arbitrarily, for example, but should be set so as to be capable of determining a vehicle VH that is to arrive soon at the garage. As an example, suppose the threshold value is set to N minutes. The controller 21 determines, as a vehicle VHi that is to arrive soon at the garage, a vehicle Vhi for which time until the time point T1 from the current time is less than N minutes, and identifies the vehicle VHi as the target vehicle VHt.

In step S3 of FIG. 6, the controller 21 of the operation management apparatus 20 acquires vehicle data D2t and/or operation record data D3t. The vehicle data D2 is obtained by monitoring the conditions of the target vehicle VHt. The operation record data D3t is obtained by monitoring travel of the target vehicle VHt. The vehicle data D2t and the operation record data D3t may be acquired in any procedure. In the present embodiment, the vehicle data D2t and the operation record data D3t is acquired in the following procedure.

The controller 21 of the operation management apparatus 20 acquires the vehicle data D2t from the target vehicle VHt. Specifically, the communicator 11 mounted in the target vehicle VHt transmits data indicating the conditions of the vehicle VHt collected from various sensors mounted in the target vehicle VHt, or measured values of control amounts or operation amounts for the vehicle VHt. The controller 21 receives, via the communication interface 23, the information or the measured values transmitted from the communicator 11, and acquires, as the vehicle data D2t, the received information or the received measured values.

The controller 21 of the operation management apparatus 20 acquires the operation record data D3t from the server apparatus 30. Specifically, the server apparatus 30 transmits the operation record data D3t obtained by monitoring travel of the target vehicle VHt during automated driving. The operation record data D3t includes information that indicates the communication state between the information processing apparatus 14 and the control apparatus 12 during the automated driving of the target vehicle VHt, the amount of sensor noise having occurred at sensors such as a camera and a lidar mounted in the information processing apparatus 14, a time period in which the vehicle VH has been temporarily remotely operated during automated driving, and the like, which are transmitted from the information processing apparatus 14 mounted in the target vehicle VHt. The operation record data D3t may further include information entered by a remote operator OP as a handoff item, the information indicating the details of an inquiry or a complaint from a passenger received during remote operation assistance for the target vehicle VHt or indicating the details of a trouble that has arisen with a passenger. The controller 21 of the operation management apparatus 20 receives, via the communication interface 23, the operation record data D3t transmitted from the server apparatus 30, to acquire the received operation record data D3t. Alternatively, instead of acquiring the operation record data D3t from the server apparatus 30, the controller 21 may receive, via the communication interface 23, a signal transmitted from the information processing apparatus 14 of the target vehicle VHt and acquire the received signal as the operation record data D3t.

In step S4 of FIG. 6, the controller 21 of the operation management apparatus 20 determines, based on the vehicle data D2t or the operation record data D3t acquired in step S3, one or more types of abnormality having occurred in the target vehicle VHt. The types of abnormality may be determined in any procedure. In the present embodiment, the types of abnormality are determined in the following procedure.

In the present embodiment, the types of abnormality include vehicle abnormality, abnormality in the information processing apparatus 14, and/or daily inspection item abnormality. The vehicle abnormality includes abnormality such as low oil pressure, tire punctures, and airbag actuation, for example. The vehicle abnormality can be determined based on the vehicle data D2t. The abnormality in the information processing apparatus 14 includes abnormality in the sensor unit 144 of the information processing apparatus 14 and the like, for example. The abnormality in the information processing apparatus 14 can be determined based on the operation record data D3t. The daily inspection item abnormality includes low tire pressure, poor brake application, low battery charge, and the like, for example. The daily inspection item abnormality may include a lost property in a vehicle. The daily inspection item abnormality can be determined based on the vehicle data D2t.

In the present embodiment, the types of abnormality may further include surrounding environmental abnormality and troubles with passengers. The surrounding environmental abnormality includes, for example, abnormality detected by the sensor unit 144 of the information processing apparatus 14 during the automated driving of the target vehicle VHt or abnormality detected by a remote operator OP on a monitor or the like during remote operation assistance for the target vehicle VHt. The surrounding environmental abnormality can be determined based on the operation record data D3t. The troubles with passengers include inquiries or complaints from passengers received by each remote operator OP during remote operation assistance for the target vehicle VHt, or unresolved troubles that have arisen with passengers. The troubles with passengers can be determined based on the operation record data D3t. This is because, as mentioned above, in a case in which information indicating abnormality or the like detected on a monitor or the like during remote operation assistance for the target vehicle VHt, information indicating the details of an inquiry or a complaint from a passenger, or information indicating the details of a trouble with a passenger has been entered into the server apparatus 30 by a remote operator OP as a handoff item, the operation record data D3t includes the information entered by the remote operator OP as the handoff item.

The controller 21 of the operation management apparatus 20 determines, based on the vehicle data D2t, the vehicle abnormality and the daily inspection item abnormality in the target vehicle VHt.

The types of abnormality based on the vehicle data D2t may be determined in any procedure. In the present embodiment, the types of abnormality are determined in the following procedure. The controller 21 of the operation management apparatus 20 determines the vehicle abnormality by signals from warning lights included in the vehicle data D2t. The controller 21 determines, based on the vehicle data D2t, one or more items obtained using an automatic inspection algorithm, as the daily inspection item abnormality. Specifically, the controller 21 detects, using any automatic inspection algorithm, the abnormality in the target vehicle VHt from each parameter value obtained as the vehicle data D2t. For example, the controller 21 refers to parameter values of the target vehicle VHt included in the vehicle data D2t, such as a tire pressure, the amount of a brake step per acceleration, and the amount of battery charge, and detects abnormality in the tire pressure, poor braking per acceleration, and the pace of battery charge reduction per unit time in the target vehicle VHt. Alternatively, in a case in which the vehicle data D2t includes images acquired by an image sensor such as a camera mounted in the target vehicle VHt, the controller 21 may detect a lost property in the vehicle by analyzing such images or by other means.

The controller 21 of the operation management apparatus 20 determines, based on the operation record data D3t, the abnormality in the information processing apparatus 14. Specifically, the controller 21 determines the abnormality in the information processing apparatus 14 based on, for example, information included in the operation record data D3t, the information indicating the communication state between the information processing apparatus 14 and the control apparatus 12 during the automated driving of the target vehicle VHt, the amount of sensor noise having occurred at the sensors such as the camera and the lidar mounted in the information processing apparatus 14, the time period in which the vehicle VH has been temporarily remotely operated during the automated driving, and the like.

The abnormality in the information processing apparatus 14 may be determined in any procedure. In the present embodiment, the abnormality is determined in the following procedure. The controller 21 of the operation management apparatus 20 determines the abnormality in the information processing apparatus 14 based on information included in the operation record data D3t, the information indicating the communication state between the information processing apparatus 14 and the control apparatus 12 during the automated driving of a vehicle VH. In the present embodiment, the control apparatus 12 receives control information from the information processing apparatus 14 at control timings that occur repeatedly at predetermined intervals (e.g., a few milliseconds). As described above, the control information is generated by the information processing apparatus 14 using automated driving software. The control apparatus 42 performs vehicle control based on the control information from the information processing apparatus 14. Here, for example, when the control apparatus 12 cannot successfully receive the control information at the next control timing due to factors such as increased processing load on the information processing apparatus 14 or decreased communication quality between the information processing apparatus 14 and the control apparatus 12, the control information that the control apparatus 12 should receive at the next control timing may be missing. The controller 21 of the operation management apparatus 20 refers to the information that indicates the communication state between the information processing apparatus 14 and the control apparatus 12, which is included in the operation record data D3t. Upon detecting that there is missing control information that should have been received by the control apparatus 12 at any control timing, the controller 21 determines that abnormality has occurred in the information processing apparatus 14.

The controller 21 of the operation management apparatus 20 may determine the surrounding environmental abnormality, as a type of abnormality based on the operation record data D3t. The surrounding environmental abnormality may be determined in any procedure. In the present embodiment, the surrounding environmental abnormality is determined in the following procedure. The controller 21 of the operation management apparatus 20 determines the surrounding environmental abnormality based on the amount of sensor noise indicated by the operation record data D3t. For example, the controller 21 can determine fog or rain as the surrounding environmental abnormality based on the amount of noise in the sensor unit 144, such as a camera or a lidar, indicated as the amount of sensor noise. The reason to determine fog or rain as the surrounding environmental abnormality is that the fog or rain may prevent hinder proper operation of the sensor unit 144 such as a lidar, and interfere with disturb automated driving. When fog or rain is determined as the surrounding environmental abnormality, the sensitivity of the sensor unit 144, such as a camera or a lidar, can be adjusted by a worker to reduce influence on automated driving.

Alternatively, in a case in which the operation record data D3t includes information entered by each remote operator OP as a handoff item, the controller 21 may determine a trouble with a passenger as a type of abnormality based on the operation record data D3t. The trouble with the passenger may be determined by any procedure. In the present embodiment, the trouble may be determined in the following procedure. The controller 21 of the operation management apparatus 20 determines, based on the information included in the operation record data D3t as the handoff item, the details of an inquiry or a complaint from a passenger received during remote operation assistance for the target vehicle VHt or a trouble that has arisen with a passenger. In a case in which a trouble with a passenger is determined, it may be considered that the trouble can be reduced or eliminated by having a worker attend to the passenger face-to-face after the automated driving of the target vehicle VHt is completed.

In step S5 of FIG. 6, the controller 21 of the operation management apparatus 20 designates a first worker MP1, from among a plurality of workers MP, according to the types of abnormality determined in step S4. The first worker MP1 may be designated by any procedure. In the present embodiment, the first worker MP1 is designated by the following procedure. The controller 21 further acquires job classification data D4 indicating, on a worker-by-worker basis, job classifications of the plurality of workers MP in association with the types of abnormality. Based on the acquired job classification data D4, the controller 21 designates, as the first worker MP1, a worker who has job classifications capable of taking care of all the determined types of abnormality or a worker who has job classifications capable of taking care of a greatest number of types of abnormality among the determined types of abnormality.

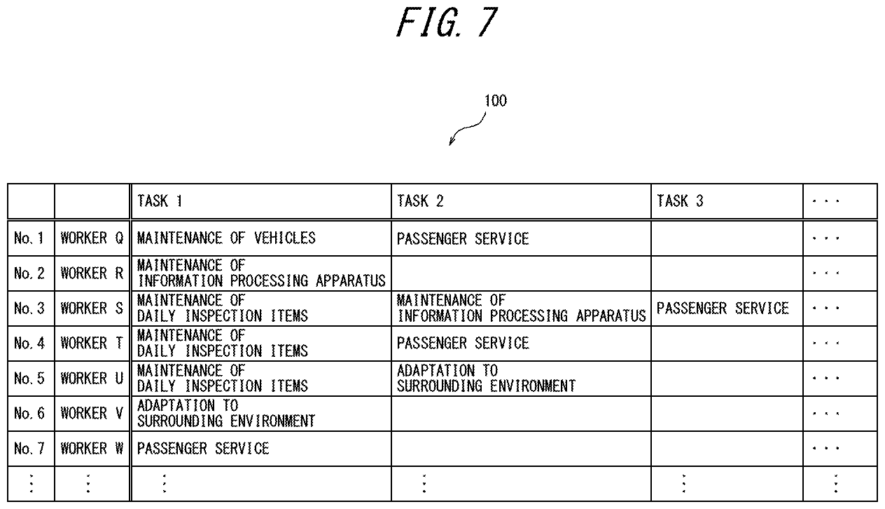

The job classification data D4 according to the present embodiment will be described with reference to FIG. 7. In the present embodiment, “job classification data” is information that indicates, on a worker-by-worker basis, job classifications of the plurality of workers MP in association with the types of abnormality. The job classifications indicate tasks which each worker MP can take care of. Such tasks include, for example, “maintenance of vehicles”, “maintenance of information processing apparatus”, “maintenance of daily inspection items”, “adaptation to surrounding environment”, and “passenger service”, as tasks which each worker MP can take care of. Each task is not limited to the above examples and may be defined arbitrarily according to the types of abnormality. As an example, workers whose job classifications include “maintenance of vehicles” can take care of vehicle abnormality by, for example, repairing low oil pressure, tire punctures, airbag actuation, or the like, which is determined as the vehicle abnormality. Workers whose job classifications include “maintenance of information processing apparatus” can take care of abnormality in the information processing apparatus 14 by, for example, repairing the sensor unit 144, which is determined as the abnormality in the information processing apparatus 14. Workers whose job classifications include “maintenance of daily inspection items” can take care of daily inspection item abnormality by performing operations such as inflating tires, adjusting brakes, or recharging batteries, for low tire pressure, poor brake application, or low battery charge, which is determined as the daily inspection item abnormality. In a case in which a lost property is determined as daily inspection item abnormality, workers can take care of the daily inspection item abnormality by retrieving the lost property. Workers whose job classifications include “adaptation to surrounding environment” can take care of surrounding environmental abnormality by, for example, adjusting the sensitivity of the sensor unit 144 of the information processing apparatus 14 for fog or rain, which is determined as the surrounding environmental abnormality, to adapt the information processing apparatus 14 to the surrounding environmental abnormality and reduce an influence of the surrounding environmental abnormality on automated driving. Workers whose job classifications include “passenger service” can take care of troubles with passengers by resolving inquiries or complaints from the passengers or troubles with the passengers. In the present embodiment, tasks which each of the plurality of workers MP can take care of are predetermined as job classifications. Each worker MP may be capable of taking care of a task for one type of abnormality.

FIG. 7 illustrates a table 100, an example of a configuration of a table which stores the job classification data D4 according to the present embodiment. In the table 100 in FIG. 7, the record in the first row contains “maintenance of vehicles” as Task 1 and “passenger service” as Task 2 for a worker Q. The record in the second row contains “maintenance of information processing apparatus” as Task 1 for a worker R. The record in the third row contains “maintenance of daily inspection items” as Task 1, “maintenance of information processing apparatus” as Task 2, and “passenger service” as Task 3 for a worker S. The record in the fourth row contains “maintenance of daily inspection items” as Task 1 and “passenger service” as Task 2 for a worker T. The record in the fifth row contains “maintenance of daily inspection items” as Task 1 and “adaptation to surrounding environment” as Task 2 for a worker U. The record in the sixth row contains “adaptation to the surrounding environment” as Task 1 for a worker V. The record in the seventh row contains “passenger service” as Task 1 for a worker W.

As an example, assume that the types of abnormality determined in step S4 are abnormality in tire pressure, which is one of daily inspection items, abnormality in the information processing apparatus 14, and a trouble with a passenger. In this case, the controller 21 of the operation management apparatus 20 refers to the table 100 in which the job classification data D4 is stored and designates the worker S as the first worker MP1. This is because the job classifications of the worker S include all the determined types of abnormality: “maintenance of daily inspection items”, “maintenance of information processing apparatus”, and “passenger service”.

Alternatively, the controller 21 of the operation management apparatus 20 may designate, as the first worker MP1, a worker who has job classifications capable of taking care of a greatest number of types of abnormality, among the determined types of abnormality. As an example, assume that the types of abnormality determined in step S4 are poor brake application, which is one of daily inspection items, surrounding environmental abnormality, and vehicle abnormality. In this case, the controller 21 of the operation management apparatus 20 refers to the table 100 in which the job classification data D4 is stored and designates the worker U as the first worker MP1. This is because, as a result of comparison between the tasks included in the job classifications of each worker MP and the determined types of abnormality, the number of types of abnormality which the job classifications of the worker U can take care of is the largest. That is, the controller 21 refers to the table 100 and determines that, among the three types of abnormality determined in step S4, i.e., “brake application failure”, “surrounding environmental abnormality”, and “vehicle abnormality”, the number of the types of abnormality which the job classifications of the worker Q can take care of is 1 (“vehicle abnormality”), the number of the types of abnormality which the job classification of the worker R can take care of is 0, the number of the types of abnormality which the job classifications of the worker S can take care of is 1 (“daily inspection item abnormality”), the number of the types of abnormality which the job classifications of the worker T can take care of is 1 (“daily inspection item abnormality”), the number of the types of abnormality which the job classifications of the worker U can take care of is 2 (“daily inspection item abnormality” and “surrounding environmental abnormality”), the number of the types of abnormality which the job classification of the worker V can take care of is 1 (“surrounding environmental abnormality”), and the number of the types of abnormality which the job classification of the worker W can take care of is 0. The controller 21 then designates the worker U who can take care of the greatest number, i.e., two types of abnormality, as the first worker MP1.

In a case in which a worker who has job classifications capable of taking care of all the determined types of abnormality cannot be designated as the first worker MP1, the controller 21 of the operation management apparatus 20 may further designate, in addition to the first worker MP1, a second worker MP2 who has a job classification capable of taking care of a type of abnormality that is not associated with the job classifications of the first worker MP1, among the determined types of abnormality. As in the example described above, assume that the types of abnormality determined in step S4 are poor brake application, surrounding environmental abnormality, and vehicle abnormality, and that the worker U who can take care of the greatest number, i.e., two types of abnormality is designated as the first worker MP1. In this case, among the three types of abnormality determined in step S4, the type of abnormality that is not associated with the job classifications of the worker U is “vehicle abnormality”. Therefore, the controller 21 refers again to the table 100 and further designates a worker who can take care of the vehicle abnormality, as the second worker MP2. Specifically, the worker Q, whose job classifications include “vehicle maintenance” is designated as the second worker MP2.

As a variant of the present embodiment, in step S5 of FIG. 6, the controller 21 may further acquire task management data D5 indicating the operation states of the plurality of workers MP in chronological order, and select, based on the operation states of the plurality of workers MP as indicated by the acquired task management data D5 at the time point T1, candidate workers MP′ to designate the first worker MP1. Specifically, the operation state of a worker includes a standby state in which the worker is not engaged in actual work, a rest state in which the worker is taking a break, or a maintenance state in which the worker is servicing a vehicle other than the target vehicle VHt. The controller 21 selects, as the candidate workers MP′, workers whose operation states at the time point T1 are the standby state. The operation state is not limited to the above examples and may be defined arbitrarily.

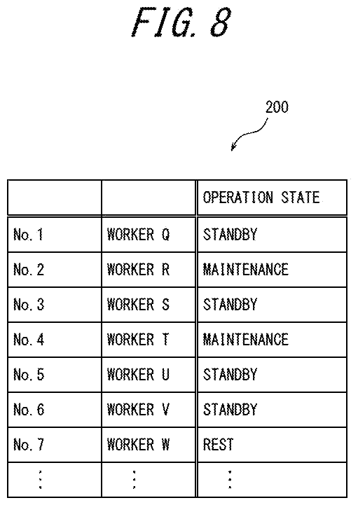

The task management data D5 according to the present embodiment will be described with reference to FIG. 8. In the present embodiment, “task management data” is information that indicates the operation states of the plurality of workers MP in chronological order. The task management data includes information that indicates the operation states of the plurality of workers MP at least at the time point T1. As mentioned above, in the present embodiment, the operation states include the standby state in which the worker is not engaged in actual work, the rest state in which the worker is taking a break, or the maintenance state in which the worker is servicing a vehicle other than the target vehicle VHt. The controller 21 selects, as the candidate workers MP′ to designate the first worker MP1, workers whose operation states at the time point T1 are the standby state.

FIG. 8 illustrates an example of configuration of a table in which the task management data D5 according to the present embodiment is stored, as a table 200.

In the table 200 in FIG. 8, the records in the second and fourth rows contain “maintenance” as the operation states of the worker R and worker T, respectively. This indicates that the workers R and T are servicing vehicles other than the target vehicle VHt. The records in the first, third, fifth, and sixth rows contain “standby” as the operation states of the worker Q, worker S, worker U, and worker V, respectively. This indicates that the workers Q, S, U, and V are on standby at a site and ready to take care of maintenance. The record in the seventh row contains “rest” as the operation state of the worker W. This indicates that the worker W is on a break. The controller 21 of the operation management apparatus 20 refers to the table 200 and selects the workers Q, S, U, and V whose operation states are “standby”, as the candidate workers MP′. In a case in which the candidate workers MP′ are selected in this manner, the controller 21 of the operation management apparatus 20, in step S5 of FIG. 6, selects the first worker MP1 from among the selected candidate workers MP′, i.e., the workers Q, S, U, and V, instead of from among the plurality of workers MP, i.e., the workers Q, R, S, T, U, V, and W . . . .

As a further variation of this variation, the controller 21 of the operation management apparatus 20 may determine whether to select the candidate workers MP′ according to the types of abnormality determined in step S4. Specifically, for example, an urgency level may be set for each type of abnormality. In a case in which urgency levels set for the determined types of abnormality are greater than or equal to a predetermined value, the controller 21 may designate, with reference to the task management data D5, workers whose operation states are “standby” as the candidate workers MP′. On the other hand, in a case in which the urgency levels for the determined types of abnormality are less than the predetermined value, the controller 21 may not select the candidate workers MP′, but may designate the first worker MP1 from among the plurality of workers MP. The reasons for setting the urgency level for each type of abnormality are as follows. For abnormality that are relatively simple to work on, general workers can take care of the abnormality. Accordingly, priority may be given to selecting candidate workers who can take care of the abnormality immediately based on the operation states of workers, and then designating a worker from among the candidate workers. On the other hand, for highly specialized abnormality, there may be a limited number of highly skilled workers who can take care of the abnormality. In such a case, priority may be given to assigning such a worker, regardless of the availability of workers with skills to take care of the abnormality. According to this example, for example, by setting a high urgency level for a type of abnormality which requires relatively low expertise of operation to work on, such as daily inspection item abnormality, maintenance work can be started immediately because a worker MP is designated from candidate workers MP′ on standby for the abnormality with relatively low expertise. On the other hand, by setting a low urgency level for a type of abnormality which requires relatively high expertise of operation to work on, such as vehicle abnormality or abnormality in the information processing apparatus 14, a worker MP is designated based on the job classifications of the worker, regardless of whether the worker is on standby or not. This makes it easier to designate a worker with appropriate skills for the abnormality with relatively high expertise.

In step S6 in FIG. 6, the controller 21 of the operation management apparatus 20 notifies the worker designated in step S5 of information that prompts the worker to take care of the abnormality. Specifically, the controller 21 notifies the first worker MP1 designated in step S5 of the information that prompts the first worker MP1 to take care of the abnormality. For example, in a case in which the type of abnormality determined in step S4 is abnormality in tire pressure, the controller 21 generates the message “Tire pressure is low. Please inflate.” and transmits the message via communication interface 23 to the terminal apparatus 40 held by the first worker MP1. The terminal apparatus 40 displays the message received from the operation management apparatus 20 on a display as an output interface.

In step S5, in a case in which the second worker MP2 is designated in addition to the first worker MP1, the controller 21 of the operation management apparatus 20 notifies the terminal apparatus 40 of the second worker MP2 in the same manner.

As described above, the operation management apparatus 20 according to the present embodiment predicts, for each vehicle based on operation plan data D1, a time point T1 at which driving is switched from automated driving to manual driving, and identifies, as a target vehicle VHt, a vehicle VHi for which time until the predicted time point T1 is less than a threshold value. The operation management apparatus 20 acquires vehicle data D2t obtained by monitoring the conditions of the target vehicle VHt and/or operation record data D3t obtained by monitoring travel of the target vehicle VHt, and determines, based on the acquired vehicle data D2t or the acquired operation record data D3t, one or more types of abnormality having occurred in the target vehicle VHt. The operation management apparatus 20 designates, from among a plurality of workers MP according to the determined types of abnormality, a first worker MP1 who is to perform maintenance work on the target vehicle VHt at a site near the target vehicle VHt. The operation management apparatus 20 notifies the first worker MP1 of information that prompts the first worker MP1 to take care of the abnormality.

According to such a configuration, a worker who is to maintain a vehicle is automatically selected as the vehicle is switched from automated driving to manual driving. Thus, time and effort required to assign the worker is reduced. Therefore, the operation efficiency of the vehicle is improved.

The present disclosure is not limited to the embodiment described above. For example, two or more blocks described in the block diagrams may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

For example, the present embodiment is applicable in a case in which one of the vehicles VH is leaving the garage after maintenance, and the operation of the vehicle is switched from manual driving to automated driving. The driving of each vehicle VH is switched from manual driving to automated driving within an automated driving transition frame in the garage. That is, as a variation of the present embodiment, the operation management apparatus 20 predicts, for each vehicle based on operation plan data D1, a time point T1′ at which the driving of each vehicle VH is switched from manual driving to automated driving, and identifies, as a target vehicle VHt, a vehicle VHi for which time until the predicted time point T1′ is less than a threshold value. In this case, the operation management apparatus 20 determines, based on operation management data D5, the operation state of each worker MP at the time point T1′, and designates, based on the determined result, a third worker MP3 who moves the target vehicle VHt to the automated driving transition frame. The operation management apparatus 20 may notify the designated third worker MP3 of information that prompts the third worker MP3 to move the target vehicle VHt to the automated driving transition frame. Alternatively, as a further variation of this variation, the operation management apparatus 20 may acquire data indicating the operation states of the plurality of remote operators OP in chronological order, and designate, based on the operation states indicated by the acquired data, a first remote operator OP1 who remotely controls the target vehicle VHt after the driving of the target vehicle VHt is switched from manual driving to automated driving. The operation management apparatus 20 may notify the designated first remote operator OP1 of information that prompts remote control of the target vehicle VHt.

1. An operation management apparatus that operates one or more vehicles by automated driving according to a schedule, the operation management apparatus comprising a controller configured to:
predict, for each vehicle based on operation plan data corresponding to the schedule, a time point at which driving is switched from automated driving to manual driving;
identify, as a target vehicle, a vehicle for which time until the predicted time point is less than a threshold value;
acquire vehicle data and/or operation record data, the vehicle data being obtained by monitoring a condition of the target vehicle, the operation record data being obtained by monitoring travel of the target vehicle;
determine, based on the acquired vehicle data or the acquired operation record data, one or more types of abnormality having occurred in the target vehicle;
designate, from among a plurality of workers according to the determined types of abnormality, a first worker who is to perform maintenance work on the target vehicle at a site near the target vehicle; and
notify the first worker of information that prompts the first worker to take care of the abnormality.

2. The operation management apparatus according to claim 1, wherein the controller is configured to:
further acquire job classification data indicating, on a worker-by-worker basis, job classifications of the plurality of workers in association with types of abnormality; and
designate, as the first worker based on the acquired job classification data, a worker who has job classifications capable of taking care of all the determined types of abnormality or a worker who has job classifications capable of taking care of a greatest number of types of abnormality among the determined types of abnormality.

3. The operation management apparatus according to claim 2, wherein in a case in which the worker who has the job classifications capable of taking care of all the determined types of abnormality cannot be designated as the first worker, the controller is configured to further designate, in addition to the first worker, a second worker who has a job classification capable of taking care of a type of abnormality that is not associated with the job classifications of the first worker, among the determined types of abnormality.

4. The operation management apparatus according to claim 1, wherein the controller is configured to determine, based on the vehicle data, one or more items obtained using an automatic inspection algorithm, as the types of abnormality.

5. The operation management apparatus according to claim 1, wherein the controller is configured to:
further acquire task management data indicating operation states of the plurality of workers in chronological order; and
select, based on the operation states of the plurality of workers as indicated by the acquired task management data at the time point, a candidate worker to designate the first worker.
